(19) United States
(12) Patent Application Publication
(10) Pub. No.: US 2025/0163270 A1
(43) Pub. Date: May 22, 2025

(54) PROCESS FOR PRODUCING ASPHALT BINDER AND ASPHALT BINDER

(71) Applicant: PETRÓLEO BRASILEIRO S.A. – PETROBRAS, Rio de Janeiro (BR)

(72) Inventors: Margareth Carvalho COUTINHO CRAVO, Rio de Janeiro (BR); Luis Alberto HERRMANN DO NASCIMENTO, Rio de Janeiro (BR); Marcio DE FIGUEIREDO PORTILHO, Rio de Janeiro (BR); Danuza NOGUEIRA MOYSES, Rio de Janeiro (BR)

(21) Appl. No.: 18/938,745

(22) Filed: Nov. 6, 2024

(30) Foreign Application Priority Data
Nov. 21, 2023 (BR) 1020230243398

(51) Int. Cl. C08L 95/00; C10G 21/00

(52) U.S. Cl. CPC C08L 95/00; C10G 21/003; C08L 2555/34

(57) ABSTRACT

The present disclosure relates to embodiments of a process for producing asphalt binder containing a mixture of soft plastics from urban solid waste rich in polypropylene and polyethylene. The asphalt binder produced may be applied in the production of diluent suitable for the production of PAC with pre-salt RASF.

### FIELD OF THE DISCLOSURE

The present disclosure is part of the oil field, more precisely in the area of refining technologies, and relates to a process for producing asphalt binder containing a mixture of soft plastics from urban solid waste rich in polypropylene and polyethylene. The asphalt binder produced is applied in the production of diluent suitable for the production of PAC with pre-salt RASF.

### BACKGROUND OF THE DISCLOSURE

For reasons of sustainability, circular economy and in compliance with several environmental commitments, there is a growing desire to reduce urban solid waste. There are several proposals for this, and among them is the immobilization of MSW in asphalt binders, which has the challenge of obtaining a homogeneous mixture when incorporating this very incompatible material, and which leads to the total segregation of the plastic fraction in the petroleum asphalt cement (PAC). Another issue is the increasing presence of pre-salt oil in the refining park, which produces vacuum residues with a consistency that is difficult to adjust for PAC, requiring a deasphalting process to obtain a more consistent RASF, sometimes with zero penetration at 25° C., and which requires a high diluent content to qualify for PAC. In this scenario, the diluent content is between 25% and 35% by mass, which can easily disqualify the product from its specification in the mass variation test due to the volume of diluent that can accumulate light particles in its composition.

### STATE OF THE ART

The document in the name of Lucena, entitled “Caracterização química e reológica de asfaltos modificados por polímeros” (Chemical and rheological characterization of polymer-modified asphalts), shows a study of the chemical and rheological characterization of asphalt cement derived from petroleum. The asphalt was modified by incorporating the polymers SBS and EVA, and the resulting effects of the modification were evaluated. However, it does not have renewable or circular content. In the present disclosure, residual plastic (PE and PP) dissolved in a heavy diesel stream was used to be added to the RASF.

The document in the name of Fontoura, entitled “Incorporação de flocos reciclados de PE em ligante asfaltico” (Incorporation of recycled PE flakes in asphalt binder”, studies the modification of a petroleum asphalt cement with the addition of plastic waste with several levels of low and high density polyethylene. Furthermore, in this document, the addition of the polymer is carried out directly into the asphalt product already specified and it is difficult to incorporate the polymer into the PAC without complete interaction. In the present disclosure, however, the RASF is used and a PAC is specified using the diesel stream with the dissolved plastic forming a stable and homogeneous product.

The document in the name of Bringel et al., entitled “Propriedades químicas e reológicas de asfalto modificado por copolímero EVA” (Chemical and rheological properties of asphalt modified by EVA copolymer), aims to characterize Brazilian asphalt cements in terms of their chemical and viscoelastic properties, as well as to evaluate the effects resulting from the modification of the asphalt binder by incorporating the EVA copolymer and EVA in the form of chips from the waste of the footwear industry. However, the addition of the polymer is carried out directly in the PAC, which is an already specified product. In contrast, in the present disclosure, an asphalt residue (RASF) is used, making it possible to specify a PAC using the diesel stream with the dissolved plastic forming a stable and homogeneous product.

The document in the name of Badejo et al., entitled “Plastic waste as strength modifiers in asphalt for a sustainable environment” investigates the applicability of polyethylene terephthalate (PET) as a strength modifier in the construction of asphalt roads. However, the addition of PET is made directly to the specified PAC, reducing consistency. In the present disclosure, PP and PE polymers dissolved in a heavy diesel stream are added to asphalt residue to reduce consistency and qualify for PAC.

The document in the name of Badejo et al., entitled “Plastic waste as strength modifiers in asphalt for a sustainable environment” investigates the applicability of polyethylene terephthalate (PET) as strength modifiers in the construction of asphalt roads. However, the addition of PET is made directly to the specified PAC, reducing consistency. In the present disclosure, PP and PE polymers dissolved in a heavy diesel stream are added to asphalt residue to reduce consistency and qualify for PAC.

In the document in the name of Jan et al., entitled “Performance evaluation of hot mix asphalt concrete by using polymeric waste polyethylene”, the modification was direct in the asphalt mixture (PAC+stone material). In the present disclosure, there is a concern in specifying the asphalt residue with PP/PE dissolved in the diesel in PAC.

The document in the name of Mendes et al., entitled “PET oligomer waste to modify PAC characteristics”, proposes an improved method of reusing polyethylene terephthalate (PET) residues in the production chain, in which the PET was chemically modified with pentaerythritol (PENTE), resulting in the oligomer PET/PENTE (60/40). The present disclosure does not use PET. In addition, the process proposed in the aforementioned document is based on the direct addition of polymer in PAC, different from the route proposed in the present disclosure, where RASF and a diesel stream in which the polymer was dissolved are used as a base.

The document in the name of Xu et al., entitled “Using waste plastics as asphalt modifier: a review”, uses the wet process where it is verified that the polymer was added directly to the PAC, promoting an increase in viscosity and generating a modified PAC with little stability during storage. The present disclosure seeks to dilute the RASF (viscosity reduction) with diesel fuel with the polymer dissolved and completely stable without segregation.

The document in the name of Ranieri et al., entitled “Asphalt surface mixtures with improved performance using waste polymers via dry and wet processes”, deals with high-density PE and EVA added directly to the 70/100 and 35/50 grades of PAC. Due to their instability during storage, they are immediately mixed with the stone material. In a different way, the present disclosure aims to produce PAC by diluting the RASF (viscosity reduction) with diesel fuel with the polymer dissolved and completely stable, without segregation.

The document US2022315765 A1 entitled “Asphalt modification with recycled plastic and crumb rubber for paving, roofing, waterproofing and damp proofing”, deals with polymers added directly to the PAC. Due to their instability during storage, they are immediately mixed with the stone material. In contrast, the present disclosure seeks to produce PAC by diluting the RASF (viscosity reduction) with diesel fuel with the polymer dissolved and completely stable, without segregation.

Based on the state of the art, it is clear that mixing plastic directly into the asphalt mix does not promote a perfect homogeneous mixture and, if not applied as soon as the mixture is prepared, there is a segregation of the plastic in relation to the original PAC formulation material. Thus, the present disclosure solves the problem in question by preparing a plastic solution by melting plastics from urban solid waste, rich in polypropylene and polyethylene, but which may contain other mixed plastics such as polyurethanes, polymethyl methacrylates, PETs, etc., using a solvent that contains at least 20% aromatic compounds in its formulation. The preparation of the mixture of plastics with MSW allows it to be added to the asphalt mixture in a more homogeneous way and with greater interaction with the original compounds of the composition, preventing the segregation of the plastic material during storage for later use.

### SUMMARY OF THE DISCLOSURE

The present disclosure is directed to embodiments of a process for producing asphalt binder containing a mixture of soft plastics from urban solid waste rich in polypropylene and polyethylene with heavy plastic petroleum gas oil. Using this process, it is possible to classify a 30/45 PAC in the penetration tests at 25° C. and Brookfield Viscosity at 177° C., generating an environmental gain with the immobilization of carbon in the asphalt binder. In addition to this circular economy issue with plastic in diesel, there is the advantage of producing a stream with the potential to be a RASF diluent.

### DETAILED DESCRIPTION OF THE DISCLOSURE

The present disclosure relates to a process for producing asphalt binder containing a mixture of soft plastics from urban solid waste rich in polypropylene and polyethylene. The process comprises the following steps.

### (a) Production of Plastic Heavy Petroleum Gas Oil (GOP)

In an autoclave-type reactor with a temperature between 170° C. and 230° C., 5% by mass of the mixture of soft plastics from useless plastic bags and films composed of polyethylene (PE) or polypropylene (PP) were dissolved for 2 hours in 95% by mass of a heavy petroleum gas oil (GOP) refinery stream with at least 21.5% aromatics in its composition. After the dissolution time, heating was stopped, and the still heated sample was filtered to remove insoluble metallic residues and solid contaminants. At the end of this procedure, a plastic GOP with greater consistency was obtained.

(b) Production of Petroleum Asphalt Binder (PAC) with Plastic Gas Oil

In a study at 165° C., let the asphalt residue (RASF), obtained from the deasphalting of pre-salt oils with a rotational viscosity of 766 cP at 177° C., flow until its complete homogenization is possible. Then, pour a known quantity by mass into the low-shear mixer vessel and add 28% by mass of previously obtained plastic GOP. Finally, keep the mixture at 165° C. with 300 rpm, adjusting the mixer for 1 hour to obtain petroleum asphalt cement (PAC).

It is worth noting that experiments were also carried out with 10% plastic from urban solid waste (MSW) but did not show complete dissolution. This thermal process generated a higher consistency diesel that, when added at approximately 28% by mass to the pre-salt RASF, was able to classify a 30/45 PAC in penetration tests at 25° C. and Brookfield Viscosity at 177° C., generating an environmental gain with the immobilization of carbon in the asphalt binder. In addition to this circular economy issue with plastic in diesel, there is the advantage of producing a stream with the potential to be a RASF diluent.

1. A process for producing asphalt binder, the process comprising:
(a) producing plastic heavy petroleum gas oil (GOP), and
(b) producing asphalt binder petroleum (PAC) with plastic gas oil.

2. The process according to claim 1, wherein step (a) comprises: in an autoclave-type reactor with a temperature between 170° C. and 230° C., 5% by mass of a mixture of soft plastics from bags and useless plastic films composed of polyethylene (PE) or polypropylene (PP) are dissolved for 2 hours in 95% by mass of a refinery stream of heavy petroleum gas oil (GOP) with at least 21.5% of aromatics in its composition.

3. The process according to claim 2, wherein after the dissolution time, heating is interrupted, and the still heated sample is filtered to remove insoluble metal residues and solid contaminants.

4. A process according to claim 1, wherein step (b) comprises: in a tank at 165° C., the asphalt residue (RASF), obtained from the deasphalting of pre-salt oils with a rotational viscosity at 177° C. of 766 cP, is allowed to flow until it is completely homogenized.

5. A process according to claim 4, wherein a known quantity by mass is poured into the low shear mixer vessel and 28% by mass of previously obtained plastic GOP is added, keeping the mixture at 165° C. with 300 rpm, and adjusting the mixer for 1 hour to obtain petroleum asphalt cement (PAC).

6. An asphalt binder as obtained in claim 1, the binder including by fitting a PAC 30/45 in the penetration tests at 25° C. and Brookfield Viscosity at 177° C.

7. An asphalt binder as obtained in claim 6, wherein step (a) comprises: in an autoclave-type reactor with a temperature between 170° C. and 230° C., 5% by mass of a mixture of soft plastics from bags and useless plastic films composed of polyethylene (PE) or polypropylene (PP) are dissolved for 2 hours in 95% by mass of a refinery stream of heavy petroleum gas oil (GOP) with at least 21.5% aromatics in its composition.

8. An asphalt binder as obtained in claim 7, wherein after the dissolution time, heating is interrupted, and the still heated sample is filtered to remove insoluble metal residues and solid contaminants.

9. A process according to claim 6, wherein step (b) comprises: in a tank at 165° C., the asphalt residue (RASF), obtained from the deasphalting of pre-salt oils with a rotational viscosity at 177° C. of 766 cP, is allowed to flow until it is completely homogenized.

10. A process according to claim 9, wherein a known quantity by mass is poured into the low shear mixer vessel and 28% by mass of previously obtained plastic GOP is added, keeping the mixture at 165° C. with 300 rpm, and adjusting the mixer for 1 hour to obtain petroleum asphalt cement (PAC).
